(19) United States
(12) Patent Application Publication
(10) Pub. No.: US 2015/0136443 A1
(43) Pub. Date: May 21, 2015

(54) CABLE WITH MULTIPLE CONDUCTORS EACH HAVING A CONCENTRIC INSULATION LAYER

(71) Applicant: Paige Electric Company, LP, Union, NJ (US)

(72) Inventor: Roger L. Rumsey, Wichita, KS (US)

(73) Assignee: Paige Electric Company, LP, Union, NJ (US)

(21) Appl. No.: 14/084,374

(22) Filed: Nov. 19, 2013

(51) Int. Cl. H01B 7/02; H01B 7/08

(52) U.S. Cl. CPC H01B 7/02; H01B 7/08
USPC 174/117 F

(57) ABSTRACT

An electrical transmission cable has at least two wires joined in side-by-side relationship by a web. Each wire has a central conductor surrounded by a single layer of insulation that has an outer surface. A majority of the outer surface of the insulation layer is concentric with the conductor. The web is attached at first and second ends to the outer layers of the insulation of the first and second wires. The web has a neck located intermediate its first and second ends with the neck defining the point of least cross-sectional area of the web. Separation of one wire from the other will cause the web to break at the neck, thereby preventing damage to the insulation layer. Chordal segments of the insulation layer may be used to minimize the width of a multi-wire cable.

### FIELD OF THE DISCLOSURE

The present disclosure is directed to electrical transmission cables.

### BACKGROUND

As used herein, the term “wire” will refer to a single, individual electrical conductor and the insulation covering that conductor. The term “cable” will refer to a collection or group of at least two wires whose insulation layers are initially joined in some manner. In the past insulated transmission cables were designed with multiple insulated wires, each of which had insulation layers that defined a generally rectangular cross-section. The individual wires were separated by V-shaped notches. FIG. 1 illustrates this construction. Cable 1 is shown having three wires 2. Each wire 2 comprises a central, cylindrical conductor 3 surrounded by an insulation layer 4 which has a generally rectangular cross-section. A series of V-shaped notches 5 are formed on or in the outer edges of the insulation layers. The notches 5 help a user separate the individual wires 2 from the cable. By aligning pairs of the V-shaped notches 5, a relatively weakened portion of the insulation is formed that allows the individual wires 2 to be separated from one another. While this prior art cable worked in the sense that individual wires could be separated from the cable, it had design flaws that inherently caused the conductors to be damaged during the removal or stripping of the insulation. This typically resulted from the insulation not tearing or separating precisely along the line defined by facing V-shaped notches. The tear line or separation line potentially would wander away from the line defined by facing V-shaped notches, leaving one of the conductors with a thinner than intended insulation thickness at the tear line.

### SUMMARY

In one aspect, the present disclosure concerns a multi-wire insulated electrical transmission cable wherein each wire comprises a conductor surrounded by an insulation layer. Each conductor has a round cross-section and the majority of the insulation layer of each wire also has a round cross-section. The majority of the outer surface of each insulation layer is concentric with the conductor. The insulation layer of each wire is connected to at least one adjacent wire by a thin web. The resulting cross-section of an adjacent pair of wires basically resembles a barbell design, wherein the web is the bar. Due to the short length and thin cross-section of the web, when one or more of the insulated wires is removed (ripped) from the group, the concentricity of the conductor and insulation layer of each individual wire is preserved.

In another aspect, the present disclosure concerns an insulated multi-wire electrical transmission cable where removal of any of the insulated wires from the other wires results in the removed wire's insulation having a majority of its outer circumference concentric with the outer circumference of the conductor.

In still another aspect, the present disclosure concerns an insulated multi-wire electrical transmission cable where a number of insulated conductors are connected by thin webs. The webs are designed to tear from the insulated wires when a tensile load is applied between two adjacent insulated wires. The web's design which allows this tearing or ripping is manufactured so that the mid-section or neck of the web is thinner than the web where it connects to the insulated wires. Since the web is short, and the neck is intermediate the ends of the web, tearing or ripping of adjacent wires occurs at the neck and as a result it does not damage the insulation of the wires and also maintains the concentricity of the conductor with the insulation layer.

In another aspect, the present disclosure concerns an insulated, multi-wire electrical transmission cable having a plurality of side-by-side wires with adjacent pairs of wires frangibly joined by a web. The overall width of the cable is minimized by facing chordal segments of the outer circumference of adjacent wires' insulation layers. The chordal segments truncates the cross-section of the insulation layers, allowing them to be joined by a short web that permits close packing of the wires.

### BRIEF DESCRIPTION OF THE DRAWINGS

FIG. 1 is a cross-section of a prior art cable.

FIG. 2 is a cross-section of a cable according to the present invention.

FIG. 3 is an enlargement of the circled portion of FIG. 2 which is labeled “FIG. 3”.

FIG. 4 is a cross-section of a cable according to an alternate embodiment of the present invention.

FIG. 5 is an enlargement of the circled portion of FIG. 4 which is labeled “FIG. 5”.

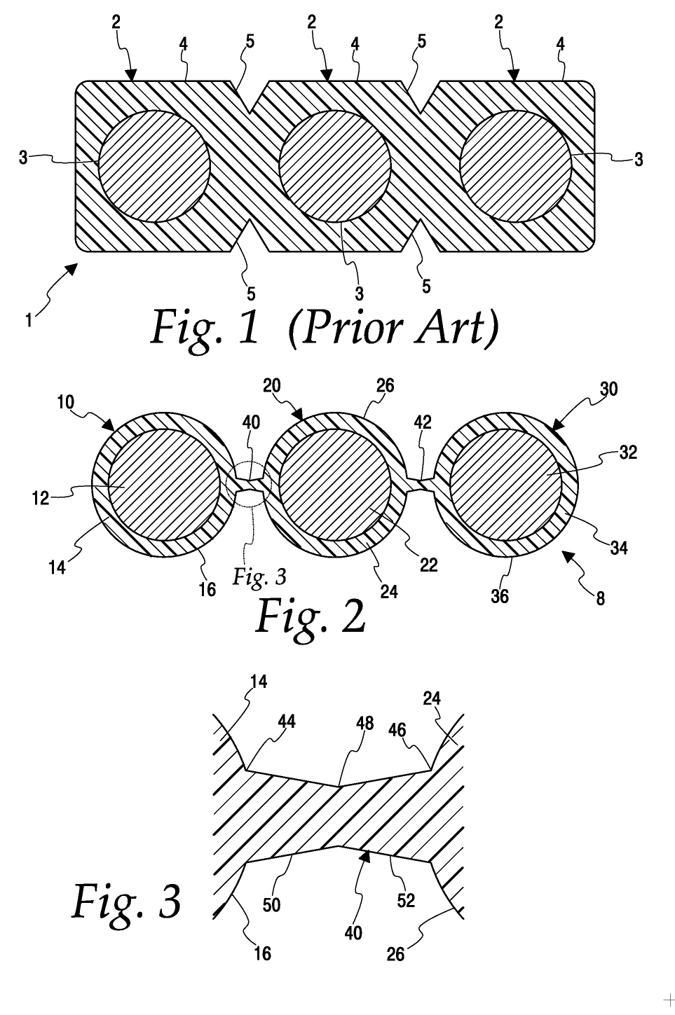

### DETAILED DESCRIPTION OF THE EMBODIMENTS

The present disclosure is directed to an electrical cable suitable for transmission. Transmission cable is distinguishable from communication cable in that communication cable has two concentric, dielectric layers surrounding a central core conductor, whereas transmission cable normally has only a single dielectric layer. Typically the inner dielectric layer of a communications cable is a foam layer and the outer dielectric layer is a tough, protective layer made of a material such as PVC, nylon or other suitable materials. The foam layer is necessary to minimize the impedance of the cable. A transmission cable does not have a foam layer.

A first embodiment of a transmission cable 8 according to the present invention is shown in FIGS. 2 and 3. The transmission cable 8 is shown having three side-by-side wires 10, 20 and 30. It will be understood that the cable 8 could have different numbers of wires than the three shown. There could be just two wires, or there could be four or more wires. Each wire has a central conductor 12, 22, 32, respectively, having a circular cross-section. The conductor is made of a suitable metal such as copper. Each conductor 12, 22, 32 is surrounded by a single layer of insulation 14, 24, 34, respectively. The insulation layers also have a circular cross-section and are concentric with the conductors 12, 22, 32, respectively. The concentric insulation and conductor facilitates stripping of the insulation after the wires have been separated from one another. Each layer of insulation has an outer surface 16, 26, 36, respectively. The insulation layers may be made of polyethylene, PVC, nylon or other suitable dielectric materials. The center-to-center distance of adjacent pairs of wires in this embodiment is greater than the sum of the radii of the insulation layers of the two adjacent wires.

Adjacent pairs of wires 10/20 and 20/30 are frangibly joined by webs 40 and 42. Details of one of the webs 40 are best seen in FIG. 3. The web has a first end 44 fixed to the outer surface 16 of the insulation layer 14 and a second end 46 fixed to the outer surface 26 of the insulation layer 24. The web may be formed integrally with the insulation layers by extrusion at the time of formation of the insulation layers. Accordingly the web extends the entire length of the cable.

The web also has a neck 48 intermediate the first and second ends 44 and 46. The neck is the point of smallest cross-sectional area of the web. The cross-sectional area referred to here is that taken along line A-A in FIG. 3. Thus the neck 48 is the weakest part of the web in tension.

When it is desired to separate an individual wire from its adjacent wire a user will pull the two wires of the pair apart which will result in a tensile load being applied to the web. This will in turn cause the web to break at the neck. Since the neck 48 is intermediate the first and second ends 44, 46, the break point will be remote from the outer surfaces of the adjoining insulation layers. This assures the insulation layer will not be damaged or compromised in its dielectric capacity by the separation process. It also assures that the outer surface of the insulation layer will be essentially concentric with the conductor. Accordingly, standard wire strippers can be used to remove the insulation layer without impinging on or otherwise damaging the conductor. Concentricity of the insulation and conductor is critical when using a clamping concentric stripper. If the concentricity of the stripper, insulation and conductor is not perfect, the strands of the conductor can be damaged. Such damage deters the conductor's ability to properly transfer the electrical energy.

It will be appreciated that with the neck 48 located intermediate the first and second ends 44, 46 of the web, a portion of the severed web will remain on each of the adjacent wires. That is, a slug of the web will remain attached to the outer surface of each insulation layer of the adjoining wires. These slugs are not of sufficient size to interfere with any subsequent stripping operation. A wire stripper will easily cut through the slug as it cuts through the insulation layer.

While the cross-section of the web 40 shown in FIG. 3 shows angled surfaces 50, 52 forming a pair of trapezoidal shapes joined at the neck, it will be understood that other shapes could be employed so long as they produce the smallest cross-sectional area of the web remote from the outer surfaces of the insulation layers. FIG. 5 illustrates one possible alternate web configuration that has an arcuate surface of the web that narrows to a minimum cross-section at the center of the web. Note also that the neck need not be in the center of the web. It could be spaced from the center so long is it is not at the ends of the web.

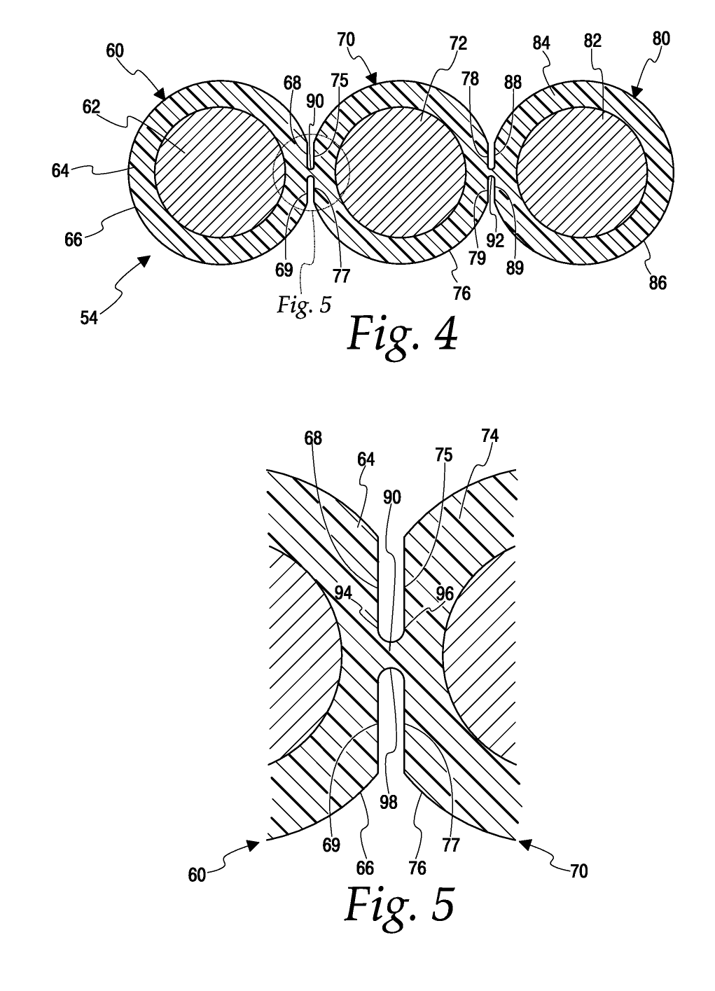

Turning now to FIGS. 4 and 5, a second embodiment a transmission cable 54 according to the present invention is shown. Once again the transmission cable 54 is shown having three side-by-side wires 60, 70 and 80, but the number of wires could be otherwise so long as there are at least two wires. As in the previous embodiment, each wire 60, 70 and 80 has a central conductor 62, 72, 82, respectively. The conductors have a circular cross-section. Each conductor 62, 72, 82 is surrounded by a single layer of insulation 64, 74, 84, respectively. Each layer of insulation has an outer surface 66, 76, 86, respectively. The insulation layers also have a circular cross-section and the majority of the circumference of outer surfaces is concentric with the conductors 62, 72, 82, respectively.

Where pairs of wires lie adjacent one another the outer surfaces of the insulation on facing portions of the pairs have a truncated cross-section defined by chordal segments. That is, the actual cross-section of the wires is truncated with respect to an imaginary, full 360° circular cross-section. This is due to the fact that the center-to-center distance between pairs of adjacent wires is less than the sum of the radii of the adjacent wires' insulation layers. Thus, the outside wire 60 has two colinear chordal segment 68 and 69. Similarly, the outside wire 80 has two colinear chordal segment 88 and 89. The middle wire 70 adjoins the two outer wires 60 and 80 and thus has four chordal segments, including collinear chordal segments 75, 77 facing wire 60 and collinear chordal segments 78 and 79 facing wire 80.

The pairs of collinear chordal segments would define most of a chord of an imaginary, full 360° circular cross-section. As can be seen in FIGS. 4 and 5, this means the wires do not have a full 360° circular cross-section. Instead the circular portion of the cross-section may extend for about 270° to about 340° or so, depending on how much truncation of the full, imaginary circle is needed to achieve the desired center-to-center distance of adjacent wires. The amount of truncation must, of course, be consistent with leaving a sufficient thickness of the insulation layer throughout the chordal segments to satisfy the dielectric properties needed for the rating of the particular cable. In the illustrated embodiment the strictly circular portion of the cross-section extends for about 320°, with the remaining 40° being subtended by the chordal segments.

Also, for purposes of this disclosure, the insulation layers of cable 54 are considered to define a circular cross-section even though the circular portion of the insulation layer does not extend a full 360°. The insulation layer extends in a circular cross-section sufficiently to define what the diameter is and where it lies, even though the cross-section is truncated at the chordal segments. It will be appreciated that the chordal segments permit a smaller center-to-center distance between adjacent wires, allowing the side-by-side wires to be closer to one another, thereby minimizing the overall width of the cable. This also reduces the weight of the cable per unit length.

The chordal segments merge with a frangible web. One web is shown at 90 and another at 92. The webs 90, 92 have a similar function to the webs 40, 42, although webs 90, 92 have a different shape, namely an arcuate shape with a minimum thickness at the center of the web. Details of one of the webs 90 are best seen in FIG. 5. The web has a first end 94 fixed to the outer surface 66 of the insulation layer 64 and a second end 96 fixed to the outer surface 76 of the insulation layer 74. The web may be formed integrally with the insulation layers by extrusion at the time of formation of the insulation layers. The web also has a neck 98 intermediate the first and second ends 94 and 96. The neck is the point of smallest cross-sectional area of the web. The cross-sectional area referred to here is similar to that taken along line A-A of FIG. 3, i.e., a section taken along a plane through the web and in a plane perpendicular to the plane of the sheet of FIG. 5. Thus the neck 98 is the weakest part of the web in tension.

Placing the neck intermediate the ends of the web assures that when a wire is separated from the cable the point of separation will be in the web and not in the insulation layer. This is particularly helpful in the design of FIGS. 4 and 5 wherein the thickness of the insulation layer is reduced adjacent the chordal segments. It is desirable to assure that the separation of the wires does not cause any failure of the insulation layer adjacent the chordal segments where such failure can least be tolerated.

It should be understood that various changes and modifications to the presently preferred embodiments described herein will be apparent to those skilled in the art. Such changes and modification can be made without departing from the spirit and scope of the invention disclosed herein.

1. An electrical transmission cable, comprising:
first and second wires each having a central conductor and a single insulation layer having an outer surface which defines a circular cross-section, a majority the outer surface of the insulation layer being concentric with the central conductor; and
a web having a first end connected to the outer surface of the first wire's insulation layer and a second end connected to the outer surface of the second wire's insulation layer.

2. The electrical transmission cable of claim 1 wherein the web further comprises a neck intermediate the first and second ends of the web, the neck defining the smallest cross-sectional area of the web.

3. The electrical transmission cable of claim 2 wherein the neck is equidistant from the first and second ends of the web.

4. The electrical transmission cable of claim 2 wherein the web has angled surfaces forming a pair of trapezoidal shapes joined at the neck.

5. The electrical transmission cable of claim 1 further comprising a third wire having a central conductor and a single insulation layer having an outer surface which defines a circular cross-section, a majority the outer surface of the insulation layer being concentric with the central conductor, the third wire being connected to the second wire by a second web, the second web having a first end connected to the outer surface of the second wire's insulation layer and a second end connected to the outer surface of the third wire's insulation layer.

6. The electrical transmission cable of claim 1 wherein the center-to-center distance of adjacent pairs of wires is greater than the sum of the radii of the insulation layers of the two adjacent wires.

7. The electrical transmission cable of claim 1 wherein the center-to-center distance of adjacent pairs of wires is less than the sum of the radii of the insulation layers of the two adjacent wires.

8. The electrical transmission cable of claim 1 wherein the web has an arcuate surface.

9. An electrical transmission cable, comprising:
first and second wires each having a central conductor and a single insulation layer having an outer surface which defines a circular cross-section, the wires further each including a chordal segment in facing relation with a chordal segment of the other wire; and
a web having a first end connected to the chordal segment of the first wire and a second end connected to the chordal segment of the second wire.

10. The electrical transmission cable of claim 9 wherein the web further comprises a neck intermediate the first and second ends of the web, the neck defining the smallest cross-sectional area of the web.

11. The electrical transmission cable of claim 10 wherein the neck is equidistant from the first and second ends of the web.

12. The electrical transmission cable of claim 9 further comprising a third wire having a central conductor and a single insulation layer having an outer surface which defines a circular cross-section, the second wire including a second chordal segment, the third wire further each including a chordal segment in facing relation with the second chordal segment of the second wire; and
a web having a first end connected to the second chordal segment of the second wire and a second end connected to the chordal segment of the third wire.

13. The electrical transmission cable of claim 1 wherein the center-to-center distance of adjacent pairs of wires is less than the sum of the radii of the insulation layers of the two adjacent wires.

14. The electrical transmission cable of claim 1 wherein the web has an arcuate surface.
